(19) United States
(12) Patent Application Publication
(10) Pub. No.: US 2024/0359605 A1
(43) Pub. Date: Oct. 31, 2024

(54) VEHICLE SEAT

(71) Applicants: NHK SPRING CO., LTD., Yokohama-shi (JP); SUBARU CORPORATION, Tokyo (JP); DENSO CORPORATION, Kariya (JP)

(72) Inventors: Kenzo YASUDA, Yokohama-shi (JP); Yosuke ISHIYAMA, Tokyo (JP); Masato FUKUSHIMA, Tokyo (JP); Shuji ITO, Kariya (JP); Naoto GOTO, Kariya (JP); Takeshi TANAKA, Kariya (JP)

(21) Appl. No.: 18/646,275

(22) Filed: Apr. 25, 2024

(30) Foreign Application Priority Data
Apr. 28, 2023 (JP) 2023-075224

(51) Int. Cl. B60N 2/56; B01D 45/08; B01D 53/26

(52) U.S. Cl. CPC B60N 2/56; B01D 45/08; B01D 53/261; B01D 2257/80

(57) ABSTRACT

A vehicle seat, includes: a cushion pad; an air passage provided inside the cushion pad, the air passage being provided with an upper opening at an upper surface side of the cushion pad and being provided with a lower opening at a lower surface side of the cushion pad; an air blower disposed at a seat lower side and connected to the lower opening of the air passage, the air blower generating an airflow in the air passage upon being operated; a lower wall forming the air passage and having the lower opening formed therein; a reinforcement plate disposed at a seat upper side of the lower wall, the reinforcement plate having a hole that is communicated with the lower opening and being configured to reinforce the lower wall; and a weir part provided around the hole of the reinforcement plate and extending toward a seat upper side.

### CROSS-REFERENCE TO RELATED APPLICATION

This application claims priority under 35 USC 119 from Japanese Patent Application No. 2023-75224 filed Apr. 28, 2023, the disclosure of which is incorporated by reference herein in its entirety.

### BACKGROUND

### Technical Field

The present disclosure relates to a vehicle seat.

### Related Art

A vehicle seat in which an air passage leading to the seating surface side is provided in the seat cushion, and an air blower is disposed at the lower end side of the air passage, is known (for example, see Japanese Patent No. 6838429).

In this kind of vehicle seat, airflow through the air passage can be created by operation of the air blower, and it is possible to draw air inward from the seating surface side or to blow air outward to the seating surface side.

### SUMMARY

However, in this kind of vehicle seat, in a case in which the seating surface is exposed to water and the water travels through the air passage and enters the air blower, this may cause the air blower to malfunction.

The present disclosure takes the above-described circumstances into consideration and obtains a vehicle seat that can prevent water from entering the air blower.

A vehicle seat according to a first aspect of the present disclosure includes: a cushion pad for a vehicle occupant; an air passage provided inside the cushion pad, the air passage being provided with an upper opening at an upper surface side of the cushion pad and being provided with a lower opening at a lower surface side of the cushion pad; an air blower disposed at a seat lower side relative to the cushion pad and connected to the lower opening of the air passage, the air blower generating an airflow in the air passage upon being operated; a lower wall forming the air passage and having the lower opening formed therein; a reinforcement plate disposed at a seat upper side of the lower wall, the reinforcement plate having a hole that is communicated with the lower opening and being configured to reinforce the lower wall; and a weir part provided around the hole of the reinforcement plate and extending toward the seat upper side.

According to the vehicle seat of the first aspect of the present disclosure, the air passage provided in the cushion pad is provided with an upper opening at the upper surface side of the cushion pad and is provided with a lower opening at the lower surface side of the cushion pad. An air blower disposed at a seat lower side with respect to the cushion pad is connected to the lower opening of the air passage, and generates an airflow in the air passage as a result of being operated. A reinforcement plate having a hole communicated with the lower opening of the lower wall is provided at a lower side of the air passage. Furthermore, a weir part extending toward the seat upper side is provided around the hole of the reinforcement plate and prevents water from flowing into the air blower. Even if water enters the air passage in a case in which the upper surface side of the cushion pad is exposed to water, since the weir part around the hole prevents water from flowing into the hole and the lower opening, water is prevented from entering the air blower.

A vehicle seat according to a second aspect of the present disclosure includes: a cushion pad for a vehicle occupant; an air passage provided inside the cushion pad, the air passage being provided with an upper opening at an upper surface side of the cushion pad and being provided with a lower opening at a lower surface side of the cushion pad; an air blower disposed at a seat lower side relative to the cushion pad and connected to the lower opening of the air passage, the air blower generating an airflow in the air passage upon being operated; a lower wall forming the air passage and having the lower opening formed therein; and a water absorbing weir part disposed at a seat upper side of the lower wall, having a communication hole communicating the air passage with the lower opening, and having absorbency to absorb moisture and rigidity to be self-supporting.

According to the vehicle seat of the second aspect of the present disclosure, the air passage provided in the cushion pad is provided with an upper opening at the upper surface side of the cushion pad and is provided with a lower opening at the lower surface ide of the cushion pad. An air blower disposed at the seat lower side with respect to the cushion pad is connected to the lower opening of the air passage, and generates an airflow in the air passage as a result of being operated. At the lower side of the air passage, a water absorbing weir part is provided, which has a communication hole that is communicated with the air passage and the lower opening of the lower wall, and which has the absorbency to absorb moisture and the rigidity to be self-supporting. When the air blower is operated, air flows from the air passage through the communication hole to the lower opening. Further, even if water enters the air passage in a case in which the upper surface side of the cushion pad is exposed to water, since the water is absorbed by the water absorbing weir part before flowing into the lower opening, water is prevented from entering the air blower.

Further, since the water absorbing weir part has the rigidity to be self-supporting, it can also function as a reinforcing material that reinforces the lower wall. The lower wall can be reinforced and water can be prevented from entering the air blower without increasing the number of parts.

A vehicle seat according to a third aspect of the present disclosure is the first aspect, in which the weir part is provided at an edge of the hole.

According to the vehicle seat of the third aspect of the present disclosure, since the weir part is provided at the edge of the hole, the weir part prevents water from flowing into the hole and into the lower opening via the edge of the hole, and therefore, it is possible to more favorably prevent water from entering the air blower.

A vehicle seat according to a fourth aspect of the present disclosure is the third aspect, in which the weir part is formed by subjecting the reinforcement plate to flange processing.

According to the vehicle seat of the fourth aspect of the present disclosure, since the weir part is formed by flanging the reinforcement plate, the reinforcement plate and the weir part can be integrally formed, and an increase in the number of parts can be suppressed. Further, since, in flange processing, the base of the rise is not a right angle but a curved surface, water and dirt can be prevented from accumulating in corner parts, as compared to the case of a right angle.

A vehicle seat according to a fifth aspect of the present disclosure is the second aspect, in which the water absorbing weir part is formed from compressed felt.

In the vehicle seat of the fifth aspect of the present disclosure, since the water absorbing weir part is formed from compressed felt, even if water were to enter the air passage, it would be absorbed by the compressed felt, thereby preventing water from entering the air blower. Further, since compressed felt can also function as a reinforcing material for reinforcing the lower wall, the lower wall can be reinforced and water can be prevented from entering the air blower without increasing the number of parts.

A vehicle seat according to a sixth aspect of the present disclosure is the third aspect, in which the weir part is formed from compressed felt.

In the vehicle seat of the sixth aspect of the present disclosure, since the weir part provided at the edge of the hole is formed from compressed felt, even if water were to enter the air passage, it would be absorbed by the compressed felt at the edge of the hole, thereby preventing water from entering the air blower. Further, since compressed felt can also function as a reinforcing material for reinforcing the lower wall, the lower wall can be reinforced and water can be prevented from entering the air blower without increasing the number of parts.

A vehicle seat according to a seventh aspect of the present disclosure is the first aspect, in which: one or more water drainage holes are formed at the lower wall of the air passage and at the reinforcement plate, and a second weir part that has absorbency to absorb moisture and rigidity to be self-supporting is provided at an edge of each of the one or more water drainage holes between the one or more water drainage holes and the hole of the reinforcement plate.

In the vehicle seat of the seventh aspect of the present disclosure, one or more water drainage holes are formed at the lower wall of the air passage and the reinforcement plate. A second weir part, which has the absorbency to absorb moisture and the rigidity to be self-supporting, is formed at the edge of each of the one or more water drainage holes between the one or more water drainage holes and the hole of the reinforcement plate. When the water cannot be completely discharged by the water drainage holes, the water that has not been discharged can be absorbed by the second weir part. Since water is prevented from flowing into the hole and the lower opening, water is prevented from entering the air blower.

A vehicle seat according to an eighth aspect of the present disclosure is the seventh aspect, in which the second weir part is formed from compressed felt.

In the vehicle seat of the eighth aspect of the present disclosure, since the second weir part provided at the edge of each of the one or more water drainage holes is formed from compressed felt, even if the water cannot be completely discharged through one or more water drainage holes, the water is absorbed by a compressed felt at the edge of each of the drain holes, thereby preventing water from entering the air blower.

A vehicle seat according to a ninth aspect of the present disclosure is any one of the first aspect, the third aspect, the fourth aspect, or the sixth to eighth aspects, in which the air blower is configured to be disposed at a seat lower side of a hip point of an occupant seated at the cushion pad.

The seat lower side of the hip point of the occupant seated on the cushion pad is a location to which water tends to flow when the seating surface is exposed to water. However, the vehicle seat according to the ninth aspect of the present disclosure is provided with a weir part that prevents water from flowing into the air blower. Even in a case in which the air blower is installed at the seat lower side of the hip point of an occupant, as in the vehicle seat of the ninth aspect of the present disclosure, since water is prevented from flowing into the hole and the lower opening by the weir part, water is prevented from entering the air blower. Since, in this way, the air blower can be installed even in locations to which water is likely to flow, the degree of freedom of the layout of the air blower can be improved.

A vehicle seat according to a tenth aspect of the present disclosure is the second aspect or the fifth aspect, in which the air blower is configured to be disposed at a seat lower side of a hip point of an occupant seated at the cushion pad.

In the vehicle seat of the tenth aspect of the present disclosure, a communication hole that is communicated with the air passage and the lower opening is formed and a water absorbing weir part is provided, which has the absorbency to absorb moisture and the rigidity to be self-supporting. Even in a case in which the air blower is installed at the seat lower side of the hip point of an occupant seated at the cushion pad, which is a location to which water is likely to flow, since water is absorbed by the water absorbing weir part before flowing into the lower opening, water is prevented from entering the air blower. Since, in this way, the air blower can be installed even in locations to which water is likely to flow, the degree of freedom of the layout of the air blower can be improved.

As explained above, according to the vehicle seat of the present disclosure, it is possible to prevent water from entering the air blower.

### BRIEF DESCRIPTION OF THE DRAWINGS

FIG. 1 is a simplified cross-sectional side view of a part of a vehicle seat according to a first embodiment of the present disclosure (a diagram corresponding to a cross section taken along the position of line 1L-1L in FIG. 3 in planar view of the vehicle seat);

FIG. 2 is an exploded perspective view showing a part of the seat cushion of FIG. 1 in an exploded and simplified manner;

FIG. 3 is a simplified top view of the seat cushion of FIG. 1 in a state viewed from above;

FIG. 4 is an enlarged view of the FC plate of FIG. 2 and its surroundings, showing a state viewed from above;

FIG. 5 is a cross-sectional view showing a state cut along line A-A in FIG. 4;

FIG. 6 is a cross-sectional view of a first variant example taken along line A-A in FIG. 4;

FIG. 7 is a cross-sectional view of a second variant example taken along line A-A in FIG. 4;

FIG. 8 is an exploded perspective view showing a part of the seat cushion of the vehicle seat according to a second embodiment of the present disclosure in an exploded and simplified manner;

FIG. 9 is an enlarged view of the FC plate of FIG. 8 and its surroundings, showing a state viewed from above; and

FIG. 10 is an enlarged sectional view showing a cross section taken along line B-B of FIG. 9.

### DETAILED DESCRIPTION

### First Embodiment

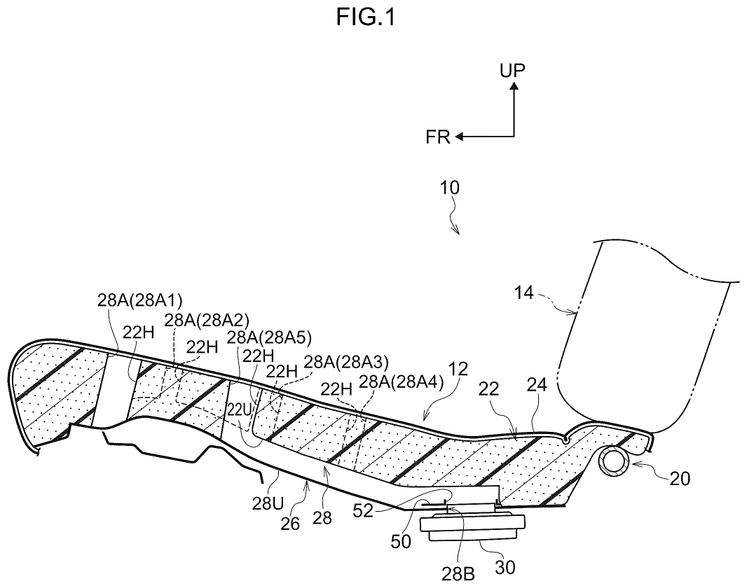

A vehicle seat according to a first embodiment of the present disclosure is explained with reference to FIG. 1 to FIG. 5. The arrow FR that is shown where appropriate in these drawings indicates a seat forward side, the arrow UP indicates a seat upper side, and the arrow W indicates a seat width direction.

### Configuration

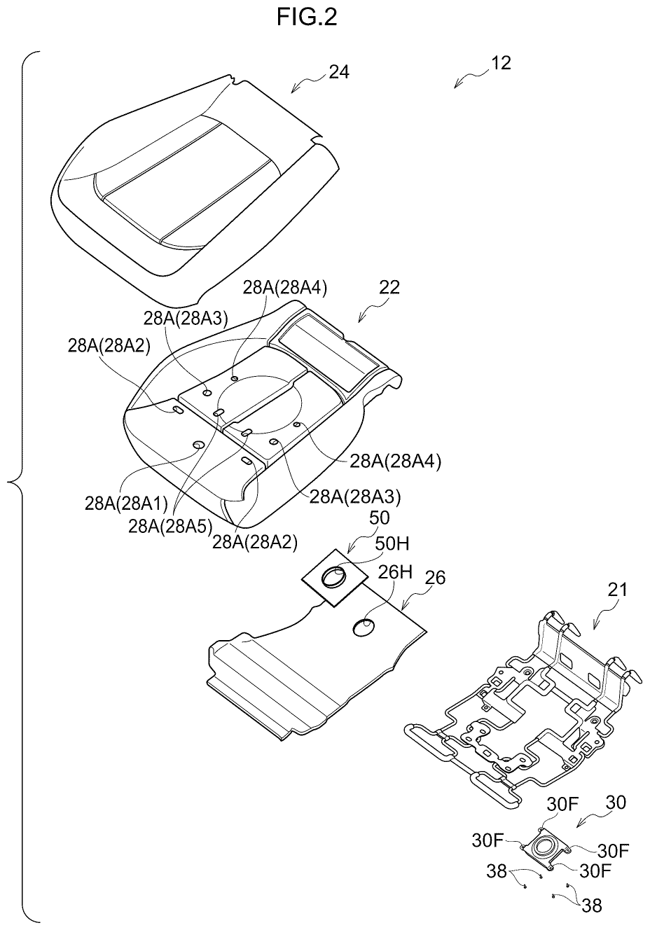

FIG. 1 shows a simplified cross-sectional side view of a part of a vehicle seat 10. Further, FIG. 2 shows a partial simplified exploded perspective view of a seat cushion 12. In addition, in FIG. 1, the cross section of a thin member is shown by a bold line without adding further thickness, for convenience. As shown in FIG. 1, the vehicle seat 10 is provided with a seat cushion 12 that supports the buttocks and thighs of a seated occupant, a seat back 14 that supports the back of the seated occupant, and a headrest (not shown) that supports the head of the seated occupant.

As shown in FIG. 2, the seat cushion 12 includes a trim cover 24, a cushion pad 22, a back face sealing material 26, an FC plate 50 as a reinforcing plate, a cushion spring 21, and a fan 30 as an air blower. As shown in FIG. 1, the seat cushion 12 includes a cushion pad 22, which is a cushioning material, that is placed on a cushion frame 20, which is a structural member, and further, the surface of the cushion pad 22 is covered with a trim cover 24, which is a skin material. The cushion pad 22 covered by the trim cover 24 is a component on which an occupant is seated. The trim cover 24 is air permeable. Although the cushion pad 22 and the trim cover 24 contact each other, they are shown slightly apart in FIG. 1 for ease of viewing. As shown in FIGS. 1 and 2, a back face sealing material 26 made of nonwoven fabric is bonded to a lower surface side of the cushion pad 22 with a hot melt adhesive (or double-sided tape).

The cushion pad 22 is formed by foam molding with a material such as polyurethane. Further, the back face sealing material 26 has lower air permeability than the cushion pad 22. An air passage 28 is provided within the cushion pad 22. The air passage 28 includes an upper opening 28A at the upper surface side of the cushion pad 22 and a lower opening 28B at the lower surface side of the cushion pad 22. The air passage 28 is formed by a through portion 22H that vertically penetrates the cushion pad 22, a recess 22U that opens toward a lower side of the seat at the bottom of the cushion pad 22, and a part of the back face sealing material 26 that is disposed at the open side of the recess 22U. A lower wall portion 28U of the air passage 28 is configured by a part of the back face sealing material 26.

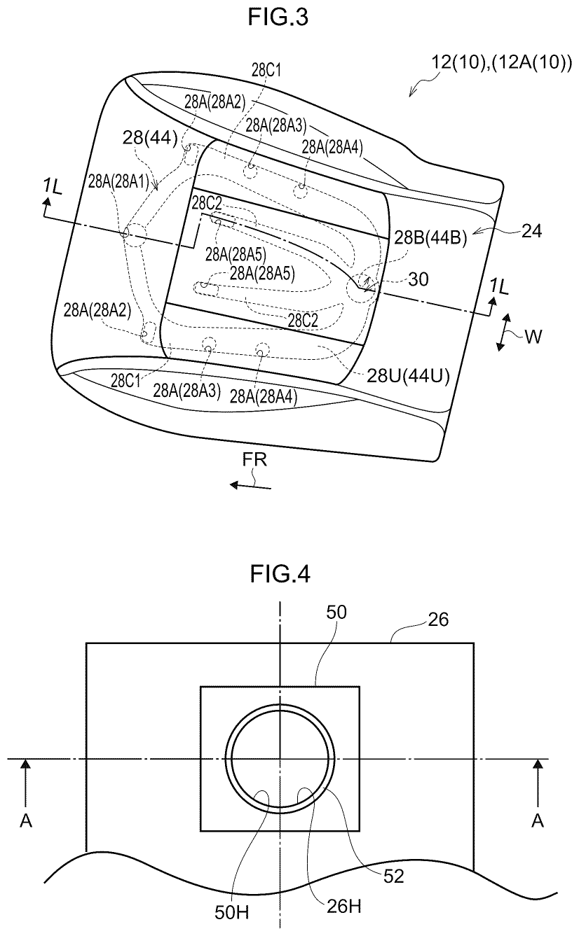

FIG. 3 shows a simplified top view of the seat cushion 12 in a state viewed from above. Although not shown in the drawings, the vehicle seat 10 is provided with a seat back and a headrest in addition to the seat cushion 12. Further, the cross section in FIG. 1 corresponds to a cross section taken along the position of line IL-IL in FIG. 3. As shown in FIGS. 1 and 2, an air passage 28 is provided within the cushion pad 22 of the seat cushion 12.

As shown in FIGS. 1 to 3, as upper openings 28A of the air passage 28, for example, a first upper opening 28A1, a left and right pair of second upper openings 28A2, a left and right pair of third upper openings 28A3, a left and right pair of fourth upper openings 28A4, and a left and right pair of fifth upper openings 28A5, are provided. The first upper opening 28A1 is formed at the front end side of the seat at a central part in the seat width direction, and the left and right pair of second upper openings 28A2 are formed at respective side portions in the seat width direction slightly further to the rear of the seat than the first upper opening 28A1.

Further, the left and right pair of third upper openings 28A3 are formed at positions at the rear side of the seat relative to the left and right pair of second upper openings 28A2, and the left and right pair of fourth upper openings 28A4 are formed at positions at the rear side of the seat relative to the left and right pair of third upper openings 28A3. Further, the left and right pair of fifth upper openings 28A5 are formed at positions at an inner side in the seat width direction relative to the left and right pair of third upper openings 28A3. In addition, in the following explanation, when describing the first upper opening 28A1, the second upper openings 28A2, the third upper openings 28A3, the fourth upper openings 28A4, and the fifth upper openings 28A5 without distinguishing therebetween, they are simply referred to as the upper opening 28A.

Further, the lower opening 28B of the air passage 28 is formed further to the rear of the seat than the left and right pair of fourth upper openings 28A4 and at a central part in the seat width direction. The lower opening 28B is larger than the upper opening 28A. The lower opening 28B is configured by a circular hole 26H in the back face sealing material 26, as shown in FIG. 2.

Further, as shown in FIG. 3, the air passage 28 includes a left and right pair of first passages 28C1 and a left and right pair of second passages 28C2. The left and right pair of first passages 28C1 converge with the passages descending from the first upper opening 28A1, the second upper openings 28A2, the third upper openings 28A3, and the fourth upper openings 28A4, and proceed to the lower opening 28B. The left and right pair of second passages 28C2 connect the passages descending from the fifth upper openings 28A5 with the lower opening 28B.

As shown in FIGS. 1 and 2, an FC plate 50 is arranged above the back face scaling material 26. The FC plate 50 is a resin plate that reinforces the back face sealing material 26, and has a hole 50H having the same shape as the circular hole 26H. The FC plate 50 is joined to the back face sealing material 26 such that the hole 50H and the circular hole 26H (lower opening 28B) are overlaid; that is, the hole 50H and the circular hole 26H are communicated with each other. Although not shown in the drawings, the fan 30 is provided with a claw portion that passes through the lower opening 28B, and this claw portion is configured to engage with the FC plate 50.

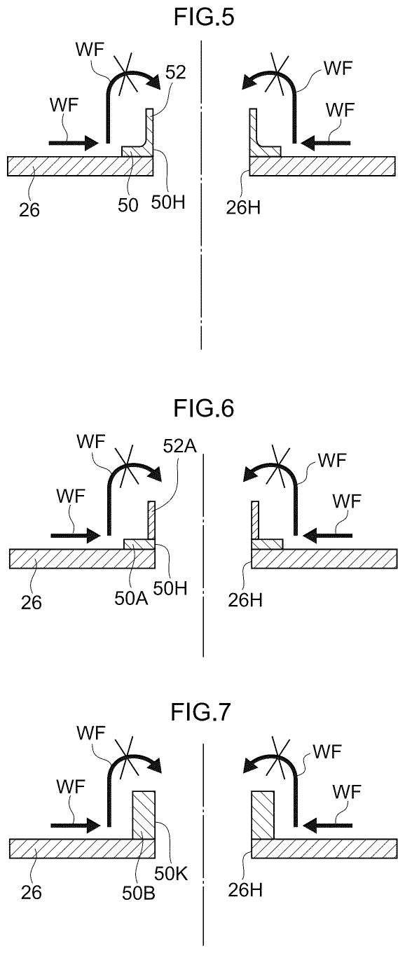

FIG. 4 shows an enlarged view of the FC plate 50 and its surroundings in a state viewed from above, and FIG. 5 shows a cross-sectional view taken along line A-A in FIG. 4. As shown in FIGS. 4 and 5, the FC plate 50 of the present embodiment is provided with a weir part 52 that extends upward at the edge of the hole 50H and prevents water from flowing into the fan 30. For example, the weir part 52 is formed by subjecting a plate material that configures the FC plate 50 to flange processing, and has a substantially cylindrical shape.

As shown in FIG. 2, the cushion spring 21 is stretched between the front and rear components of the cushion frame 20 (see FIG. 1) in the front-rear direction of the seat, and elastically supports the cushion pad 22 from the lower side of the seat. Further, as shown in FIGS. 1 and 2, a fan 30 as an air blower (also referred to as a “ventilation fan”) is disposed at a seat lower side relative to the cushion pad 22, the back face sealing material 26, and the cushion spring 21. The fan 30 is connected to the lower opening 28B of the air passage 28 and causes air flow in the air passage 28 when operated.

The fan 30 is disposed so as to draw in air within the air passage 28 when activated. Thereby, the upper opening 28A of the air passage 28 functions as an air intake port. In the following explanation, the upstream side of the airflow when the fan 30 is in operation is simply abbreviated as the “upstream side,” and the downstream side of the airflow is simply abbreviated as the “downstream side.”

Further, as shown in FIG. 2, attachment portions 30F at the four corners of the fan 30 are fixed to the cushion spring 21 using self-tapping screws 38. Note that in FIG. 1 showing the first embodiment, illustration of the cushion spring 21 shown in FIG. 2 is omitted.

### Regarding Manufacture of Cushion Pad Assembly

The cushion pad 22, back face sealing material 26, and FC plate 50 shown in FIG. 2 configure a cushion pad assembly. The manufacture of this cushion pad assembly will be outlined.

In regard to manufacturing the cushion pad assembly, as a pre-process, the FC plate 50 and the back face scaling material 26 are joined together to manufacture a sub-assembly. For this joining, for example, hot melt adhesive, sewing by sewing machine, or double-sided tape can be applied. Further, the cushion pad 22 is manufactured by foam molding in a different process from the above-described sub-assembly process. Then, the sub-assembly is attached to the lower surface of the cushion pad 22 using hot melt adhesive or double-sided tape. A cushion pad assembly can be manufactured.

### Mechanism and Effects

Next, the mechanism and effects of the first embodiment are explained.

In the present embodiment, as shown in FIG. 1, a fan 30 is arranged at a seat lower side relative to the cushion pad 22 at which the air passage 28 is provided. When the fan 30 operates, it draws air inside the air passage 28 from the lower opening 28B of the air passage 28. As a result, an air flow is generated in the air passage 28 from the upper opening 28A to the lower opening 28B, and the air in the space above the seat cushion 12 (the space surrounding the buttocks and thighs of the seated occupant) is cooled. Further, the air flow can eliminate stuffiness in the vicinity of the seating surface of the seat cushion 12 when an occupant is seated, thereby achieving a dehumidifying effect.

Here, an FC plate 50 having a hole 50H communicated with the lower opening 28B of the lower wall portion 28U is provided above the lower wall portion 28U of the air passage 28, as shown in FIG. 5. Further, around the hole 50H of the FC plate 50, a weir part 52 is provided that extends toward the seat upper side and prevents water from flowing into the fan 30. Therefore, even if water WF enters the air passage 28 when the upper surface side of the cushion pad 22 is exposed to water, around the hole 50H, the weir part 52 prevents water WF from flowing into the hole 50H or the lower opening 28B (circular hole 26H), and therefore, water WF is prevented from entering the fan 30. This prevents or suppresses failure of the fan 30 due to rust or the like.

Further, in the first embodiment, since the weir part 52 is provided at the edge of the hole 50H, the weir part 52 prevents water WF from flowing into the hole 50H or the lower opening 28B at the edge of the hole 50H, and therefore, the entry of water WF into the fan 30 can be more favorably prevented.

Further, in the first embodiment, since the weir part 52 is formed by flanging the FC plate 50, the FC plate 50 and the weir part 52 can be integrally formed, and an increase in the number of parts can be suppressed. Further, since, in flange processing, the base of the rise is not a right angle but a curved surface, water and dirt can be prevented from accumulating in corner parts compared to the case of a right angle.

As a case in which water WF enters the air passage 28, a case is presumed in which, for example, it enters via a hole disposed between the occupant's thighs or the like in a case in which an occupant is seated on the vehicle seat 10 shown in FIG. 1.

Further, as a case in which water WF enters the air passage 28 in a case in which no occupant is seated on the vehicle seat 10, a case is presumed in which, for example, a PET bottle is thrown on the surface of the seat cushion 12 by an occupant sitting in a seat (not shown) next to the vehicle seat 10, the bottle cap is not tightly fastened, and the cap comes off and water inside the PET bottle spills out.

As described above, according to the vehicle seat 10 shown in FIG. 1 of the first embodiment, water can be prevented from entering the fan 30. Since the fan 30 does not need to be made waterproof, the size of the fan 30 and the cost of anti-inundation measures can be reduced.

### First Variant Example of First Embodiment

In the first embodiment, the weir part 52 is formed by flanging the FC plate 50; however, as a first variant example of the first embodiment, the weir part 52 may be formed by a method other than flange processing. FIG. 6 shows a cross-sectional view of the first variant example taken along line A-A in FIG. 4. In FIG. 6, components that are the same as those in the first embodiment are indicated by the same reference numerals, and detailed description thereof is omitted.

As shown in FIG. 6, the weir part 52A of the first variant example is provided at the edge of the hole 50H of the FC plate 50A. The weir part 52A is formed in a cylindrical shape having the same inner diameter as the hole part 50H, and is fixed to the FC plate 50A by a known technique such as welding or adhesive. The weir part 52A may be made of the same material as the FC plate 50A, or may be made of a different material. The different material may be, for example, a material such as compressed felt, which has the absorbency to absorb moisture and has the rigidity to be self-supporting.

Even with the first variant example of the first embodiment shown in FIG. 6, in a case in which the upper surface side of the cushion pad 22 is exposed to water, as in the first embodiment, even if water WF enters the air passage 28, since the weir part 52A at the edge of the hole 50H prevents water WF from flowing into the hole 50H or the lower opening 28B (circular hole 26), water WF is prevented from entering the fan 30. This prevents or suppresses failure of the fan 30 due to rust or the like.

Further, since the weir part 52A is provided at the edge of the hole 50H, the weir part 52A at the edge of the hole 50H prevents water WF from flowing into the hole 50H or the lower opening 28B, and therefore, the entry of water WF into the fan 30 can be more favorably prevented.

Further, in a case in which the weir part 52A is formed of compressed felt, even if water WF enters the air passage 28, the water WF is absorbed by the compressed felt at the edge of the hole 50H, and therefore, water WF is prevented from entering the fan 30.

### Second Variant Example of First Embodiment

In the first embodiment, the weir part 52 is formed by flanging the FC plate 50; however, as a second variant example of the first embodiment, the weir part 52 does not have to be formed on the FC plate 50. FIG. 7 shows a cross-sectional view of the second variant example taken along line A-A in FIG. 4. In FIG. 7, components that are the same as those in the first embodiment are indicated by the same reference numerals, and detailed description thereof is omitted.

As shown in FIG. 7, in the second variant example, the FC plate 50 is not provided. The weir part 50B of the second variant example is provided with a communication hole 50K that is disposed above the back face sealing material 26 and communicates the air passage 28 (see FIG. 1) with the circular hole 26H (lower opening 28B). In the second variant example, the weir part 50B is formed in a cylindrical shape having an inner diameter that is the same as that of the circular hole 26H, and is fixed to the back face sealing material 26 using a known technique such as adhesive. The inner hole of the weir part 50B is the communication hole 50K. The weir part 50B of the second variant example is a water absorption weir part that has the absorbency to absorb moisture and has the rigidity to be self-supporting, and is made of a material such as compressed felt.

Even with the second variant example of the first embodiment shown in FIG. 7, in a case in which the upper surface side of the cushion pad 22 is exposed to water, as in the first embodiment, even if water WF enters the air passage 28, the weir part 50B around the circular hole 26H (lower opening 28B) prevents the water WF from flowing into the lower opening 28B (circular hole 26H), and therefore, water WF is prevented from entering the fan 30. This prevents or suppresses failure of the fan 30 due to rust or the like.

Furthermore, since the weir part 50B is provided at the edge of the circular hole 26H (lower opening 28B), since the weir part 50B at the edge of the circular hole 26H (lower opening 28B) prevents water WF from flowing into the lower opening 28B, the entry of water WF into the fan 30 can be more favorably prevented.

Further, the weir part 50B has a communication hole 50K that is communicated with the air passage 28 and the circular hole 26H (lower opening 28B), and has the absorbency to absorb moisture and has the rigidity to be self-supporting. Therefore, when the fan 30 is in operation, air flows from the air passage 28 to the lower opening 28B through the communication hole 50K. In addition, in a case in which the upper surface side of the cushion pad 22 is exposed to water, even if water WF enters the air passage 28, the water WF is absorbed by the weir part 50B before flowing into the lower opening 28B, and therefore, water WF is prevented from entering the fan 30.

Further, since the weir part 50B has the rigidity to stand on its own, it can also function as a reinforcing material that reinforces the lower wall portion 28U (back face sealing material 26). Thereby, the lower wall portion 28U (back face sealing material 26) can be reinforced and water WF can be prevented from entering the fan 30 without increasing the number of parts.

In the second variant example, the communication hole 50K is provided so as to overlap with the circular hole 26H (lower opening 28B) as shown in FIG. 7, but the present disclosure is not limited thereto. For example, in the case of a configuration in which the upper side of the weir part 50B is closed, the communication hole may be configured to communicate with the circular hole 26H from a side face thereof. Even with this configuration, air can flow from the air passage 28 to the circular hole 26H (lower opening 28B) via the communication hole, and water WF can be absorbed by the weir part 50B.

### Second Embodiment

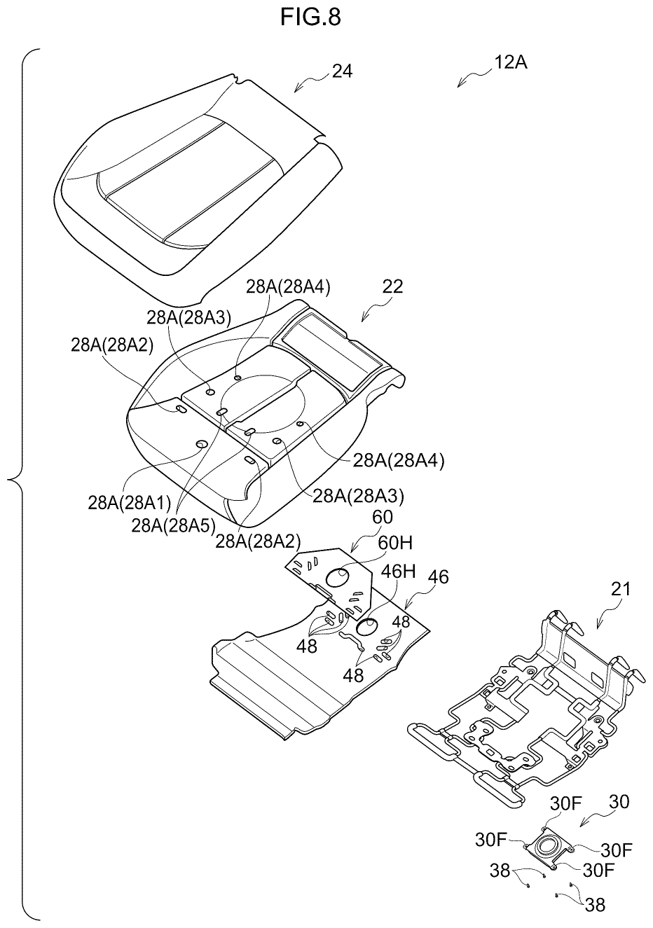

Next, a vehicle seat according to a second embodiment of the present disclosure is explained with reference to FIGS. 8 to 10. Components that are substantially identical to those of the first embodiment are indicated with the same reference numerals for convenience, and description thereof is omitted as appropriate.

### Configuration

An air passage 44 (see FIG. 3) is provided within the cushion pad 22 of the seat cushion 12A. The air passage 44 is different from the air passage 28 of the first embodiment (see FIGS. 1 to 5) in terms of a part of the configuration of its lower wall portion 44U; however, since the remainder is substantially the same as the air passage 28 of the first embodiment, components that are substantially the same are given the same reference numerals and explanation is omitted.

FIG. 8 shows a partial exploded perspective view of the seat cushion 12A. As shown in FIG. 8, the seat cushion 12A includes a trim cover 24, a cushion pad 22, a back face scaling material 46, an FC plate 60, a cushion spring 21, and a fan 30.

The trim cover 24, cushion pad 22, cushion spring 21, and fan 30 have the same configuration as in the first embodiment.

While the back face sealing material 46 is different from the back face sealing material 26 of the first embodiment in that it is further provided with water drainage holes 48 for draining off water, the configuration is otherwise substantially the same as that of the back face sealing material 26 of the first embodiment. The FC plate 60 is a resin plate that reinforces the back face sealing material 46, and is disposed in place of the FC plate 50 (see FIG. 2) of the first embodiment. The lower wall portion 44U of the air passage 44 is configured by a part of the back face sealing material 46. The lower opening 44B formed at the lower surface side of the cushion pad 22 (see FIG. 8) in the air passage 44 indicated by a dot line in FIG. 3 is configured by the circular hole 46H of the back face scaling material 46 and a hole 60H of the FC plate 60 shown in FIG. 8.

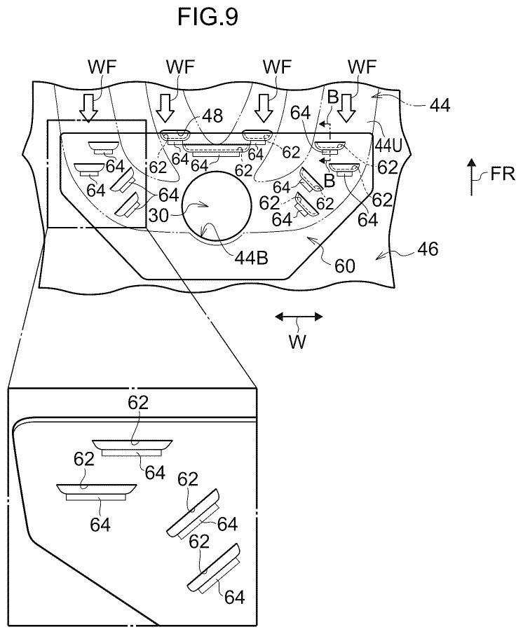

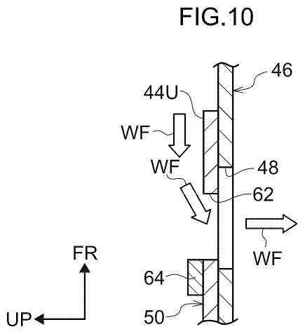

FIG. 9 shows an enlarged view of the FC plate 60 and its surroundings as viewed from above. The partially enlarged view of FIG. 9 is viewed from above the seat and slightly diagonally forward. Further, in FIG. 9, the outer shape of the air passage 44 in plan view is shown by a two-dot chain line. FIG. 10 shows an enlarged cross-sectional view taken along line B-B in FIG. 9. As shown in FIGS. 9 and 10, slit-shaped water drainage holes 62 are provided in the lower wall portion 44U of the air passage 44.

As shown in FIG. 9, each water drainage hole 62 has a longitudinal direction that intersects with the direction of extension of the air passage 44 when viewed in a vertical direction of the seat. The water drainage holes 62 are arranged along the direction of extension of the air passage 44 so as to alternate toward left and right, and are each formed at a position that includes the widthwise center portion of the air passage 44. The positions of the water drainage holes 62 are configured such that a wire harness (not shown), in particular, the end portion of the wire harness (a connector not covered by a tube or branching point) is unlikely to be exposed to water when water is drained downward from the water drainage holes 62.

Further, as shown in FIGS. 8 and 10, water drainage holes 48 for draining water are formed through the back face sealing material 46 in a range including portions corresponding to the water drainage holes 62 and their surrounding areas (see FIG. 8). As shown in FIG. 9, the front end side of the FC plate 60 has a portion at which water drainage holes 62 (for convenience, assigned the same reference numeral as the water drainage holes 62 described above) are formed together with a part of the water drainage holes 48 of the back face sealing material 46.

As shown in the partially enlarged view of FIG. 9, a second weir part 64 is provided at an edge of each long side of the water drainage holes 62. Each weir parts 64 has the absorbency to absorb moisture and has the rigidity to be self-supporting, and is made of a material such as compressed felt. Each second weir part 64 absorbs water WF that has entered the air passage 44 and has not been discharged in a case in which the water cannot be discharged from the water drainage hole 62. To explain more specifically, as shown in the partially enlarged view of FIG. 9 and in FIG. 10, each second weir part 64 extends toward the seat upper side at an edge of a long side, which is closer to the lower opening 44B, of each water drainage hole 62 (see FIG. 9).

### Mechanism and Effects

Next, the mechanism and effects of the second embodiment are explained.

In the vehicle seat 10 of the second embodiment, the drain holes 48, 62 are formed at the lower wall portion 44U of the air passage 44 and the FC plate 60. An edge of each of the one or more drain holes 48, 62 is provided with the weir part that has the absorbency to absorb moisture and has the rigidity to be self-supporting. Therefore, when the water WF cannot be completely discharged by the water drainage holes 48, 62, the water WF that has not been discharged can be absorbed by the second weir part 64. This prevents the water WF from flowing into the hole 60H and the lower opening 44B, thereby preventing the water WF from entering the fan 30.

### Supplementary Explanation of Embodiments

While explanation has been given regarding examples of the present disclosure, the present disclosure is not limited by the foregoing, and it will be apparent that various modifications may be implemented within a range not departing from the scope of the present disclosure.

What is claimed is:

1. A vehicle seat, comprising:
a cushion pad for a vehicle occupant;
an air passage provided inside the cushion pad, the air passage being provided with an upper opening at an upper surface side of the cushion pad and being provided with a lower opening at a lower surface side of the cushion pad;
an air blower disposed at a seat lower side relative to the cushion pad and connected to the lower opening of the air passage, the air blower generating an airflow in the air passage upon being operated;
a lower wall forming the air passage and having the lower opening formed therein;
a reinforcement plate disposed at a seat upper side of the lower wall, the reinforcement plate having a hole that is communicated with the lower opening and being configured to reinforce the lower wall; and
a weir part provided around the hole of the reinforcement plate and extending toward a seat upper side.

2. A vehicle seat, comprising:
a cushion pad for a vehicle occupant;
an air passage provided inside the cushion pad, the air passage being provided with an upper opening at an upper surface side of the cushion pad and being provided with a lower opening at a lower surface side of the cushion pad;
an air blower disposed at a seat lower side relative to the cushion pad and connected to the lower opening of the air passage, the air blower generating an airflow in the air passage upon being operated;
a lower wall forming the air passage and having the lower opening formed therein; and
a water absorbing weir part disposed at a seat upper side of the lower wall, having a communication hole communicating the air passage with the lower opening, and having absorbency to absorb moisture and rigidity to be self-supporting.

3. The vehicle seat of claim 1, wherein the weir part is provided at an edge of the hole.

4. The vehicle seat of claim 3, wherein the weir part is formed by subjecting the reinforcement plate to flange processing.

5. The vehicle seat of claim 2, wherein the water absorbing weir part is formed from compressed felt.

6. The vehicle seat of claim 3, wherein the weir part is formed from compressed felt.

7. The vehicle seat of claim 1, wherein one or more water drainage holes are formed at the lower wall of the air passage and at the reinforcement plate, and a second weir part that has absorbency to absorb moisture and rigidity to be self-supporting is provided at an edge of each of the one or more water drainage holes between the one or more water drainage holes and the hole of the reinforcement plate.

8. The vehicle seat of claim 7, wherein the second weir part is formed from compressed felt.

9. The vehicle seat of claim 1, wherein the air blower is configured to be disposed at a seat lower side of a hip point of an occupant seated at the cushion pad.

10. The vehicle seat of claim 2, wherein the air blower is configured to be disposed at a seat lower side of a hip point of an occupant seated at the cushion pad.
